(19) United States
(12) Patent Application Publication
(10) Pub. No.: US 2011/0143614 A1
(43) Pub. Date: Jun. 16, 2011

(54) PLASTIC SUBSTRATES AND METHODS OF FABRICATING THE SAME

(75) Inventors: Seongdeok AHN, Daejeon (KR); Seung Youl KANG, Daejeon (KR)

(73) Assignee: ELECTRONICS AND TELECOMMUNICATIONS RESEARCH INSTITUTE, Daejeon (KR)

(21) Appl. No.: 12/829,835

(22) Filed: Jul. 2, 2010

(30) Foreign Application Priority Data
Dec. 11, 2009 (KR) 10-2009-0123350

(51) Int. Cl. D03D 9/00; B32B 37/02

(52) U.S. Cl. 442/1; 156/60; 977/742; 977/750; 977/752

(57) ABSTRACT

Provided is a plastic substrate. The plastic substrate includes a carbon nanotube thin film having a matrix type mesh shape, and a plastic thin film support configured to at least fill spaces of the matrix type mesh shape and cover one side of the carbon nanotube thin film. The plastic substrate may have a low coefficient of thermal expansion and be flexible and conductive.

### CROSS-REFERENCE TO RELATED APPLICATIONS

This U.S. non-provisional patent application claims priority under 35 U.S.C. §119 of Korean Patent Application No. 10-2009-0123350, filed on Dec. 11, 2009, the entire contents of which are hereby incorporated by reference.

### BACKGROUND OF THE INVENTION

The present invention disclosed herein relates to plastic substrates and methods of fabricating the plastic substrate, and more particularly, to plastic substrates having a low coefficient of thermal expansion and methods of fabricating the plastic substrates.

Most displays are flat panel displays (FPDs), and examples of FPDs include liquid crystal displays (LCDs), plasma display panels (PDPs), and organic light emitting diode (OLED) displays. More interest has arisen recently in flexible devices, and thus research and development of such flexible devices has been carried out. However, glass substrates of FPDs have limitations on fabrication of flexible devices. Thus, there is a growing interest in plastic substrates suitable for flexible devices. Generally, characteristics of plastic substrates such as thermal characteristics, chemical resistance, gas-blocking ability, and flatness are poor as compared with those of glass substrates, and thus improvements of physical characteristics of plastic substrates are required for commercialization of plastic substrates.

There are ongoing attempts to develop plastic substrates having coefficient of thermal expansion (CTE) similar to that of glass. However, such plastic substrates have not yet been developed.

### SUMMARY OF THE INVENTION

The present invention provides a flexible and conductive plastic substrate having a low coefficient of thermal expansion.

The present invention also provides a method of fabricating a flexible and conductive plastic substrate having a low coefficient of thermal expansion.

The present invention is not limited to those mentioned above, and the present invention will be apparently understood by those skilled in the art through the following description.

Embodiments of the present invention provide plastic substrates. The plastic substrates may include: a carbon nanotube thin film having a matrix type mesh shape; and a plastic thin film support configured to at least fill spaces of the matrix type mesh shape and cover one side of the carbon nanotube thin film.

In some embodiments, the carbon nanotube thin film may include entangled carbon nanotubes. The carbon nanotubes may include at least one type carbon nanotubes selected from the group consisting of single-walled carbon nanotubes, double-walled carbon nanotubes, multi-walled carbon nanotubes, and combinations thereof.

In still other embodiments, the plastic thin film support may include a polymer. The polymer may include at least one selected from the group consisting of PolyEtherSulfone (PES), PolyCarbonate (PC), Polyethylene Naphthalate (PEN), Polyethylene Terephthalate (PET), Polynoborene, and AryLite.

In yet other embodiments, the plastic substrate may have a multi-layer structure formed by a plurality of substrates each including the carbon nanotube thin film and the plastic thin film support.

In other embodiments of the present invention, methods of fabricating a plastic substrate are provided. The methods may include: forming a carbon nanotube thin film having a matrix type mesh shape; and forming a plastic thin film support so as to fill at least spaces of the matrix type mesh shape and cover one side of the carbon nanotube thin film.

In some embodiments, the carbon nanotube thin film may be formed by entangling carbon nanotubes.

In other embodiments, the forming of the carbon nanotube thin film may include: preparing a polymer/carbon nanotube solution; forming a polymer/carbon nanotube thin film by evaporating a solvent of the polymer/carbon nanotube solution; while evaporating the solvent, forming the polymer/carbon nanotube thin film in a matrix type mesh shape; and removing a polymer from the matrix type mesh shaped polymer/carbon nanotube thin film.

In still other embodiments, the preparing of the polymer/carbon nanotube solution may include: dispersing carbon nanotubes into a polymer; and adding a solvent to the polymer in which the carbon nanotubes are dispersed.

In even other embodiments, the forming of the polymer/carbon nanotube thin film in the matrix type mesh shape may be performed by imprinting the matrix type mesh shape in the polymer/carbon nanotube thin film using a stamp substrate including protrusions.

In yet other embodiments, the removing of the polymer may be performed by heat-treating the matrix type mesh shaped polymer/carbon nanotube thin film.

In further embodiments, the forming of the plastic thin film support may include: preparing the plastic thin film support including filing parts corresponding to the spaces of the matrix type mesh shape of the carbon nanotube thin film; and bonding the plastic thin film support and the carbon nanotube thin film together.

In still further embodiments, the forming of the plastic thin film support may include: filling the spaces of the matrix type mesh shape of the carbon nanotube thin film with a polymer in a manner such that the polymer covers the one side of the carbon nanotube thin film; and hardening the polymer.

In even further embodiments, the methods may further include stacking substrates each including the carbon nanotube thin film and the plastic thin film support.

According to the embodiments of the present invention, since the plastic substrate includes the carbon nanotube thin film having a matrix shape and formed of a carbon-containing material, the coefficient of thermal expansion of the plastic substrate can be reduced. Therefore, stable flexible devices can be provided.

In addition, according to the embodiments of the present invention, since the plastic substrate includes the carbon nanotube thin film having a matrix shape and formed of a carbon-containing material, the plastic substrate can be conductive. Therefore, the plastic substrate can be used in various application fields, and flexible devices can be fabricated by using the plastic substrate having various application fields.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view illustrating a plastic substrate according to an embodiment of the present invention; and

FIGS. 2 to 6 are perspective views for explaining processes in a method of fabricating a plastic substrate according to an embodiment of the present invention.

### DETAILED DESCRIPTION OF PREFERRED EMBODIMENTS

Preferred embodiments of the present invention will be described below in more detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout the disclosure.

In the following description, the technical terms are used only for explaining a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. It will be understood that when an element such as a layer, film, region, or substrate is referred to as being “on” another element, it can be directly on the other element or intervening elements may also be present.

Additionally, the embodiment in the detailed description will be described with sectional views as ideal exemplary views of the present invention. Also, in the drawings, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. For example, although an etch region is illustrated as being rectangular, the etch region may have other shapes such as a rounded or curved shape. Areas exemplified in the drawings have general properties, and are used to illustrate a specific shape of a device region. Thus, this should not be construed as limiting the scope of the present invention.

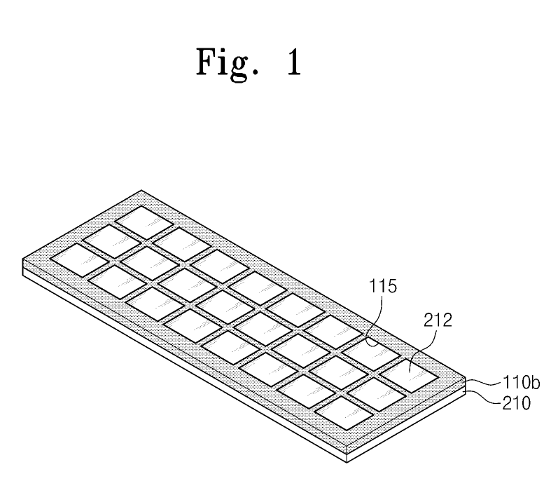

FIG. 1 is a perspective view illustrating a plastic substrate according to an embodiment of the present invention.

Referring to FIG. 1, the plastic substrate includes a carbon nanotube thin film 110b and a plastic thin film support 210.

The carbon nanotube thin film 110b may have a matrix type mesh shape. The mesh shape may have intervening spaces 115. The carbon nanotube thin film 110b may be formed of entangled carbon nanotubes. The carbon nanotubes may include at least one type carbon nanotubes selected from the group consisting of single-walled carbon nanotubes, double-walled carbon nanotubes, multi-walled carbon nanotubes, and combinations thereof. The carbon nanotube thin film 110b may be used as an optical film.

The plastic thin film support 210 may include filling parts 212 corresponding to the spaces 115 of the mesh-shaped carbon nanotube thin film 110b so as to fill the spaces 115. The plastic thin film support 210 may include a polymer. The polymer may include at least one selected from the group consisting of PolyEtherSulfone (PES), PolyCarbonate (PC), Polyethylene Naphthalate (PEN), Polyethylene Terephthalate (PET), Polynoborene, and AryLite.

In FIG. 1, the plastic substrate has a single layer structure constituted by the carbon nanotube thin film 110b and the plastic thin film support 210; however, the plastic substrate may have multiple layers each constituted by the carbon nanotube thin film 110b and the plastic thin film support 210.

Since the plastic substrate of the current embodiment includes the carbon nanotube thin film 110b having a matrix shape and formed of a carbon-containing material, a coefficient of thermal expansion of the plastic substrate can be reduced. Therefore, flexible devices may be stably fabricated using the plastic substrate.

In addition, since the plastic substrate of the current embodiment includes the carbon nanotube thin film 110b having a matrix shape and formed of a carbon-containing material, the plastic substrate can be conductive. Therefore, the plastic substrate can be used in various application fields, and flexible devices can be fabricated by using the plastic substrate having various application fields.

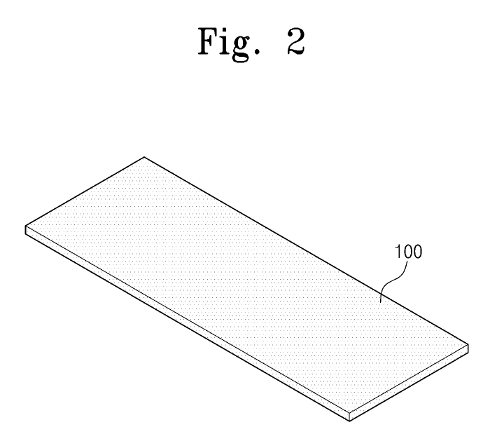

FIGS. 2 to 6 are perspective views for explaining processes in a method of fabricating a plastic substrate according to an embodiment of the present invention.

Referring to FIG. 2, a polymer/carbon nanotube solution 100 is prepared. The polymer/carbon nanotube solution 100 may include a polymer, carbon nanotubes, and a solvent. The polymer/carbon nanotube solution 100 may be prepared by mixing a solvent with a polymer in which carbon nanotubes are dispersed.

The polymer may be used for uniformly dispersing the carbon nanotubes into the polymer/carbon nanotube solution 100 and may be removed through a later heat treatment process. The carbon nanotubes may include at least one type carbon nanotubes selected from the group consisting of single-walled carbon nanotubes, double-walled carbon nanotubes, multi-walled carbon nanotubes, and combinations thereof.

Although only the polymer/carbon nanotube solution 100 is illustrated in FIG. 2, a container may also be necessary for receiving the polymer/carbon nanotube solution 100.

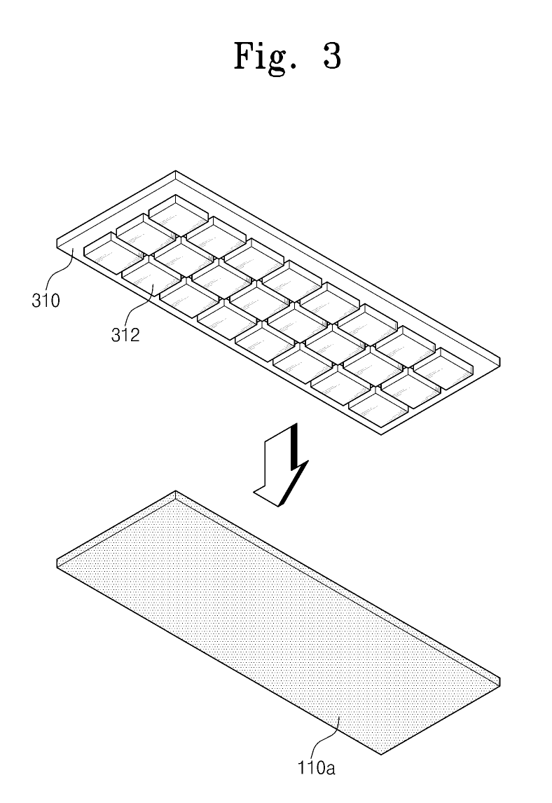

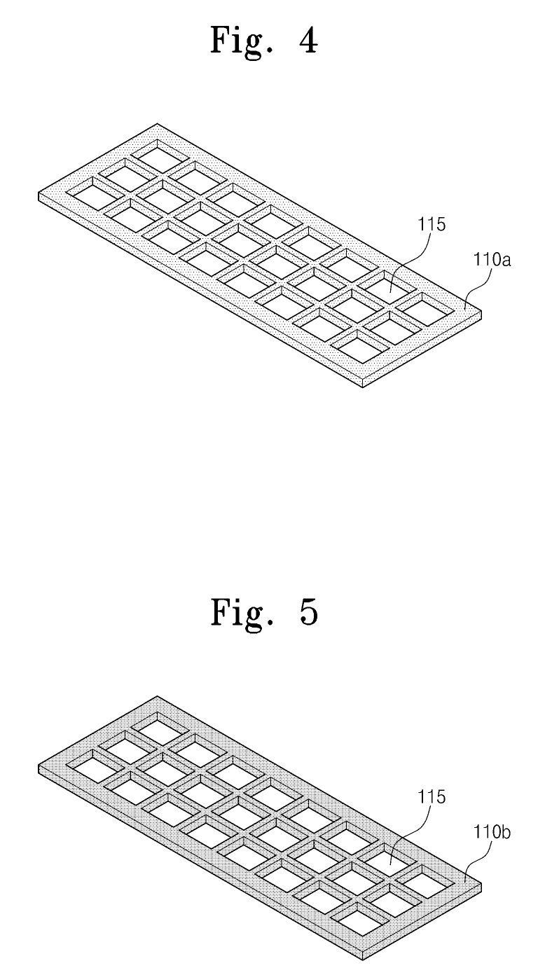

Referring to FIGS. 3 and 4, the solvent included in the polymer/carbon nanotube solution 100 is evaporated to form a polymer/carbon nanotube thin film 110a. When the solvent included in the polymer/carbon nanotube solution 100 is evaporated, the temperature of the polymer/carbon nanotube solution 100 may be decreased.

While evaporating the solvent of the polymer/carbon nanotube solution 100, an imprinting process (as indicated by an arrow) is performed on the polymer/carbon nanotube thin film 110a by using a stamp substrate 310 having protrusions 312. In detail, as the polymer/carbon nanotube thin film 110a is slowly pressed by the stamp substrate 310, the polymer and carbon nanotubes included in the polymer/carbon nanotube thin film 110a are pushed by the protrusions 312 of the stamp substrate 310, and the carbon nanotubes included in the polymer/carbon nanotube thin film 110a are entangled. Therefore, after the solvent is completely evaporated, the polymer/carbon nanotube thin film 110a can have a matrix type mesh shape. Spaces 115 corresponding to the protrusions 312 of the stamp substrate 310 may be formed in the polymer/carbon nanotube thin film 110a having the matrix type mesh shape.

Referring to FIG. 5, the polymer included in the polymer/carbon nanotube thin film 110a having the matrix type mesh shape is completely removed. The polymer may be removed by performing a heat treatment process on the polymer/carbon nanotube thin film 110a having the matrix shape mesh shape. Then, a carbon nanotube thin film 110b having the matrix type mesh shape may be formed. The carbon nanotube thin film 110b having the matrix type mesh shape may be used as an optical film.

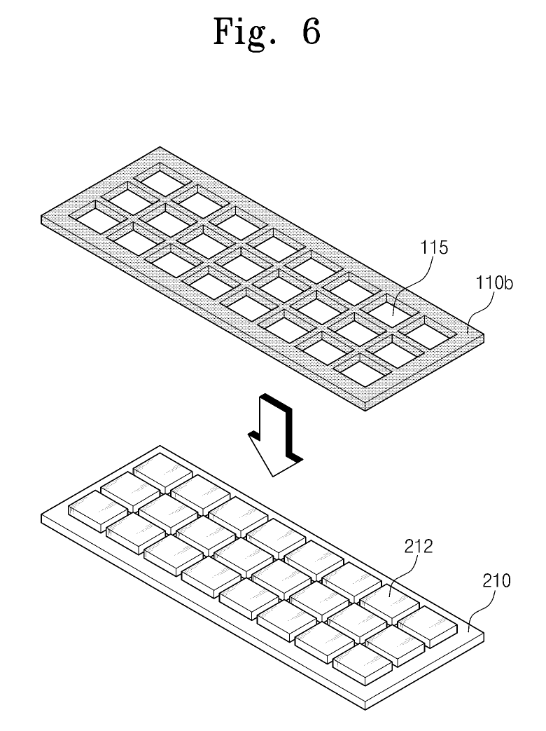

Referring to FIG. 6, a plastic thin film support 210 is formed so as to fill the spaces 115 of the carbon nanotube thin film 110b having the matrix type mesh shape and covers one side of the carbon nanotube thin film 110b.

The plastic thin film support 210 may include filling parts 212 corresponding to the spaces 115 of the carbon nanotube thin film 110b having the matrix type mesh shape, so as to fill the spaces 115. The plastic thin film support 210 may be formed of a polymer. The polymer may include at least one selected from the group consisting of PolyEtherSulfone (PES), PolyCarbonate (PC), Polyethylene Naphthalate (PEN), Polyethylene Terephthalate (PET), Polynoborene, and AryLite.

As shown in FIG. 6, a plastic substrate may be formed by preparing the plastic thin film support 210 having the filling parts 212 corresponding to the spaces 115 of the carbon nanotube thin film 110b having the matrix type mesh shape, and bonding the plastic thin film support 210 to the plastic thin film support 210 (as indicated by an arrow).

Unlike that shown in FIG. 6, a plastic substrate may be formed by filling the spaces 115 of the carbon nanotube thin film 110b having the matrix type mesh shape with a polymer in a manner such that the polymer covers one side of the carbon nanotube thin film 110b, and hardening the polymer.

In this way, as shown in FIG. 1, a plastic substrate including a carbon nanotube thin film 110b having the matrix type mesh shape can be formed.

Since the plastic substrate fabricated according to the current embodiment includes the carbon nanotube thin film 110b having a matrix shape and formed of a carbon-containing material, a coefficient of thermal expansion of the plastic substrate can be reduced. Therefore, flexible devices may be stably fabricated using the plastic substrate.

In addition, since the plastic substrate fabricated according to the current embodiment includes the carbon nanotube thin film 110b having a matrix shape and formed of a carbon-containing material, the plastic substrate can be conductive. Therefore, the plastic substrate can be used in various application fields, and flexible devices can be fabricated by using the plastic substrate having various application fields.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A plastic substrate comprising:
a carbon nanotube thin film having a matrix type mesh shape; and
a plastic thin film support configured to at least fill spaces of the matrix type mesh shape and cover one side of the carbon nanotube thin film.

2. The plastic substrate of claim 1, wherein the carbon nanotube thin film comprises entangled carbon nanotubes.

3. The plastic substrate of claim 2, wherein the carbon nanotubes comprise at least one type carbon nanotubes selected from the group consisting of single-walled carbon nanotubes, double-walled carbon nanotubes, multi-walled carbon nanotubes, and combinations thereof.

4. The plastic substrate of claim 1, wherein the plastic thin film support comprises a polymer.

5. The plastic substrate of claim 4, wherein the polymer comprises at least one selected from the group consisting of PolyEtherSulfone (PES), PolyCarbonate (PC), Polyethylene Naphthalate (PEN), Polyethylene Terephthalate (PET), Polynoborene, and AryLite.

6. The plastic substrate of claim 1, wherein the plastic substrate has a multi-layer structure formed by a plurality of substrates each comprising the carbon nanotube thin film and the plastic thin film support.

7. A method of fabricating a plastic substrate, comprising:
forming a carbon nanotube thin film having a matrix type mesh shape; and
forming a plastic thin film support so as to fill at least spaces of the matrix type mesh shape and cover one side of the carbon nanotube thin film.

8. The method of claim 7, wherein the carbon nanotube thin film is formed by entangling carbon nanotubes.

9. The method of claim 7, wherein the forming of the carbon nanotube thin film comprises:
preparing a polymer/carbon nanotube solution;
forming a polymer/carbon nanotube thin film by evaporating a solvent of the polymer/carbon nanotube solution;
while evaporating the solvent, forming the polymer/carbon nanotube thin film in a matrix type mesh shape; and
removing a polymer from the matrix type mesh shaped polymer/carbon nanotube thin film.

10. The method of claim 9, wherein the preparing of the polymer/carbon nanotube solution comprises:
dispersing carbon nanotubes into a polymer; and
adding a solvent to the polymer in which the carbon nanotubes are dispersed.

11. The method of claim 9, wherein the forming of the polymer/carbon nanotube thin film in the matrix type mesh shape is performed by imprinting the matrix type mesh shape in the polymer/carbon nanotube thin film using a stamp substrate comprising protrusions.

12. The method of claim 9, wherein the removing of the polymer is performed by heat-treating the matrix type mesh shaped polymer/carbon nanotube thin film.

13. The method of claim 7, wherein the forming of the plastic thin film support comprises:
preparing the plastic thin film support comprising filing parts corresponding to the spaces of the matrix type mesh shape of the carbon nanotube thin film; and
bonding the plastic thin film support and the carbon nanotube thin film together.

14. The method of claim 7, wherein the forming of the plastic thin film support comprises:
filling the spaces of the matrix type mesh shape of the carbon nanotube thin film with a polymer in a manner such that the polymer covers the one side of the carbon nanotube thin film; and
hardening the polymer.

15. The method of claim 7, further comprising stacking substrates each comprising the carbon nanotube thin film and the plastic thin film support.
